(19) United States
(12) Patent Application Publication
(10) Pub. No.: US 2013/0317893 A1
(43) Pub. Date: Nov. 28, 2013

(54) SYSTEM AND METHOD FOR COORDINATING EVENT PARTICIPATION AND PAYMENT

(71) Applicant: SOFTECH, INC., Lowell, MA (US)

(72) Inventors: Colin Nelson, Medfield, MA (US); Jesse Bischoff, Meriden, CT (US); Spencer Eriksen, Bethlehem, CT (US)

(21) Appl. No.: 13/901,059

(22) Filed: May 23, 2013

Related U.S. Application Data
(60) Provisional application No. 61/651,192, filed on May 24, 2012.

(51) Int. Cl. G06Q 10/02

(52) U.S. Cl. CPC G06Q 10/02
USPC 705/14.5; 705/39; 705/40

(57) ABSTRACT

The invention generally relates to systems and methods for coordinating participation in, and payment for, events. In particular, the invention allows a person to initiate a group event without exposing themselves to a full cost of the event, even where full payment is traditionally collected through a single bill or prior to the event. In some aspects, the invention provides a method of organizing an event that includes broadcasting information about an event to potential participants, receiving a commitment to pay from participants, and charging each participant their share while paying a full event cost, so that no one person must pay the full cost.

### CROSS-REFERENCE TO RELATED APPLICATION

This application claims the benefit of, and priority to, U.S. Provisional Application 61/651,192 filed May 24, 2012, the contents of which are incorporated by reference.

### FIELD OF THE INVENTION

The invention generally relates to systems and methods for coordinating participation in, and payment for, events. In particular, the invention allows a person to initiate a group event and collect contribution from participants without exposing themselves to a full cost.

### BACKGROUND

It can be a significant hassle to organize a group to participate in an event. Not only is scheduling complicated, collecting fair payment from participants can be difficult.

To illustrate, if a college student wants to get a bunch of friends together to go to a concert, she must first invite them all and have them say yes. But then, concert tickets require prepayment in full. For one person to make this purchase poses a real risk of loss if even a single participant “no shows”. Further, even if everyone does pay sooner or later, the organizer is severely limited in the number of friends she can invite, because she has to foot the entire bill out-of-pocket up front. Where a credit card is used, credit limits offer further limitations.

Related problems arise in other circumstances. Where, for example, three couples try a new fine dining restaurant together, the arrival of the bill can be awkward. If one couple had aperitifs, two bottles of wine, and specialty coffees at desert, while another couple are teetotalers, and another person had only a salad that evening, splitting the bill is difficult. The actual calculations may be difficult or erroneous. Further, being perceived as too uptight (a “penny pincher”) or too indifferent may strain business relationships and friendships. Simple check-splitting tools as described, for example, in U.S. Pub. 2013/0041824 to Gupta or U.S. Pub. 2010/0274680 to Carlson, do not resolve the problems of no-shows and the risk of a single payer footing more than their share.

These problems are compounded for complex events. If two families—such as a couple with four children and a single parent with two children—wish to spend a week at the beach, the shared costs and planning requirements include travel costs, a rental cottage, an amusement park visit, as well as miscellaneous food and amusements. These families have to allocate and pay some of these costs up-front (rentals and tickets) and manage costs during the vacation (movie tickets, popcorn, and drinks for nine on a rainy day). As vacation time approaches and gets underway, any participant may feel very anxious about finances, unsure if they are paying an appropriate share, not having any ongoing accounting of their costs, and not having any good tools to pre-pay where necessary for a share of costs that is fairly attributable to them. Additionally, the rental agency, travel agency, amusement vendors, and restaurant may be missing a significant opportunity to market their goods as a package to the families. Other situations where significant problems arise involve shared costs that are recurring in instance, such as monthly rent or housing expenses.

### SUMMARY

The invention provides a method and system for planning an event and coordinating cost-sharing and participation without requiring a single payer to bear the entire cost. Through the use of the system, a person can initiate an event, for example, inviting other people to join. The system allocates cost of the event among participants. Each person can accept an invitation or indicate an intention to participate in the event while also indicating a willingness or commitment to pay their share. The system includes tools for cost allocation, such as payment information or agreements to pay, such that system users can plan events, invite people, or coordinate complex events, without themselves being exposed to the total cost.

A person or group can use the system before, during, or after an event. For example, an organizer can send out an invitation (e.g., directly to selected friends or broadcast to a group). The organizer may establish specified minimums and maximum participant levels and cost amounts to determine a range of the financial obligation. Participants' acceptances of the invitation indicate not only an intention to join the event, but also a commitment to pay. In certain embodiments, accepting an invitation will require, for example, putting payment information into the system, such as a credit card number or linking one's system account to a payment service.

Use of the system can be initiated during an event. When the check comes at a restaurant, one person can invite the other members to use systems and methods of the invention. Information about the dinner can be digitally presented to the diners (e.g., the restaurant may be a user of the system and share the check in-system; a diner may use their phone to take a picture of the check and create an itemized copy via optical character recognition). The various diners can use the organizing diner's phone, or their own phones, to allocate items on the bill. A press of a button can then initiate payment in-full to the restaurant while each diner pays their share.

Related uses and applications of systems and methods of the invention can support vendors in creating complex, multi-part offers by allocating costs among vendors and matching offers to consumer interests. Using tools of the invention includes vendors allocating the cost of an offer made to a consumer within a digital offer safe. Where a consumer has an indication of an interest or a willingness to receive an offer, vendors can cooperate to create and deliver multi-part offers. The personalized nature of an offer directed at an identified consumer with the intent that the identified consumer may accept the offer improves over prior art advertising as a tool by which vendors may build and nurture relationships with valuable customers. For example, a consumer expresses interest in motorcycling. A motorcycle manufacturer can create a personalized learner package with lessons, a motorcycle, and necessary safety gear—all offered optionally on the condition that that consumer accept the package. Additionally, using tools of the invention, the lead vendor (here, the motorcycle manufacturer) can create a multi-part offer with identified components (lessons, gear) and then invite other vendors to provide those components of the offer as joint offer-makers.

In certain aspects, the invention provides a computer-based method for coordinating a multi-component offer by showing to a vendor an interest that a consumer has listed in a profile, receiving an offer comprising a first component from the vendor, and adding a second component associated with a second vendor to the offer. A total cost that includes a first portion associated with the first component and a second portion associated with the second component is created and shared with the consumer along with the offer. The consumer gives an indication of acceptance including a commitment to pay the total cost. The computer system is then used for facilitating provision of the components to the consumer and allocating the first portion to the first vendor and the second portion to the second vendor. The method may include requiring the consumer to commit to pay an entirety of the cost to receive the first component and the second component. The consumer may be informed of a retail cost of the first component combined with the second component that is higher than the total cost.

The consumer may be an individual. However, the consumer can be a group of participants. In some embodiments, no participant is charged the total cost. Credit card information can be taken from a participant prior to receiving a commitment to pay from a participant. Preferably, a participant's commitment to pay is included in a communication indicating the commitment to pay.

### BRIEF DESCRIPTION OF THE DRAWINGS

FIG. 1 is a diagram of a computer system according to certain embodiments.

FIG. 2 is a flow chart of method according to certain embodiments.

FIG. 3 is a flow chart for peer-to-peer methods according to certain embodiments.

FIG. 4 shows an event list display.

FIG. 5 shows a display for receiving event information.

FIG. 6 shows a display for operation of methods of the invention.

FIG. 7 gives a schematic of a vendor cost allocation tool.

FIG. 8 shows an exemplary structure for an OfferSafe.

FIG. 9 describes an exemplary logical structure of an offer.

FIG. 10 depicts a method of receiving multi-component offers.

FIG. 11 depicts a process for cost allocation from a merchant viewpoint.

FIG. 12 shows a process from the viewpoint of the vendor cost allocation tool.

### DETAILED DESCRIPTION

The invention provides a service (e.g., web-based, implemented via mobile apps, server-client computer implemented, or peer-to-peer) that facilitates the organization and cost allocation for a group event. In certain embodiments, someone comes up with the event idea (“event leader”), broadcasts the idea to his social group (e.g., on Facebook, through email, or similar), receives feedback or informal commitments from friends regarding attendance and then that event leader can purchases tickets via a service such as, for example, Ticketmaster, thereby getting a block of seats that are together.

In certain embodiments, the event leader uses a virtual “V” card, issued by a provider, to make a purchase. The use of the V card ensures that vendor specific memberships is not necessary and the transaction is seamless requiring no plug-ins or prior authorization thereby offering an “open loop” system. After submitting the event, the event leader will receive the V Card. The leader will then proceed to make the intended purchase with the V Card, and when the card is used the proportional charges will be allocated to each of the member's credit or debit card or other suitable payment system (e.g., PayPal, EFT, ACH).

In alternative embodiments, systems and methods of the invention are provided by an entity that makes payment (e.g., on behalf of the event leader) through the use of the entity's own credit facility. For example, the event leader invites participants to an event through the use of a mobile app, program, or social networking feature that is provided by the entity that also provides payment services.

As implemented in some embodiments, the invention does not include or provide a payment service. Systems and methods of the invention can allocate costs, initiate payment, manage commitments to pay, or otherwise relate to finances through the use of a traditional credit card or similar payment arrangement. In certain embodiments, systems and methods of the invention include a payment system such as, for example, credit card, PayPal or an electronic funds transfer system.

The invention generally provides a group activity facilitator that provides a more efficient and more responsible method for an organizer to invite friends and acquaintances to a group event. The facilitator system may be implemented via standalone programs (e.g., mobile apps) or through integration within an existing system (e.g., social networking site). In certain embodiments, participants may use systems and methods of the invention to form groups. An event leader announces an event idea. A subset of the social group that states an interest in attending may commit to attending via systems and methods of the invention. Systems and methods of the invention may require a user to have a credit card on file such that making a commitment to attend something would include a financial commitment to pay.

Payment of the full cost may be by any suitable means known in the art including, for example, through the use of a V card. Upon obtaining the commitment from the participants, the event leader will submit the event and the service will issue a V card to purchase the goods or services. The V card is offered by an independent third party provider aligned with the service. The event leader acquires the goods or services with the V card, upon which such costs are allocated on a previously agreed to manner to each individual participant's credit cards or offer immediate satisfaction via bank transfer. There is no need for the service, or the event leader, to front the bill. In some embodiments, payment involves a purchase by a company administering the system, a purchase using the leader's credit card, or a purchase in which the price is allocated across the suitable credit cards.

In certain embodiments, an event leader makes the purchase on a credit card and gives event or payment information into a computer system, uses the computer system to allocate cost to each participant. Reimbursement of the event leader can be automated when the leader makes the purchase with the V card. Generally, when a V card embodiment is provided, one participant in an event will be an event leader, although roles can be shared. In other aspects or embodiments, the event leader may make a purchase through a one-use credit card as provided by, for example, systems and methods of the invention or the system will initiate payment by other methods (i.e., the system entity “fronts” payment). Systems and methods of the invention then bill each attendee and receive payment (e.g., in a low-cost/no-cost method). Systems and methods of the invention can take advantage of a float, i.e. initiates payment of a credit card in 30 to 60 days (depending on the credit card billing cycle) but requires or receives payment from event participants in 5 to 10 days. Other variations will be evident to one having ordinary skill in the art.

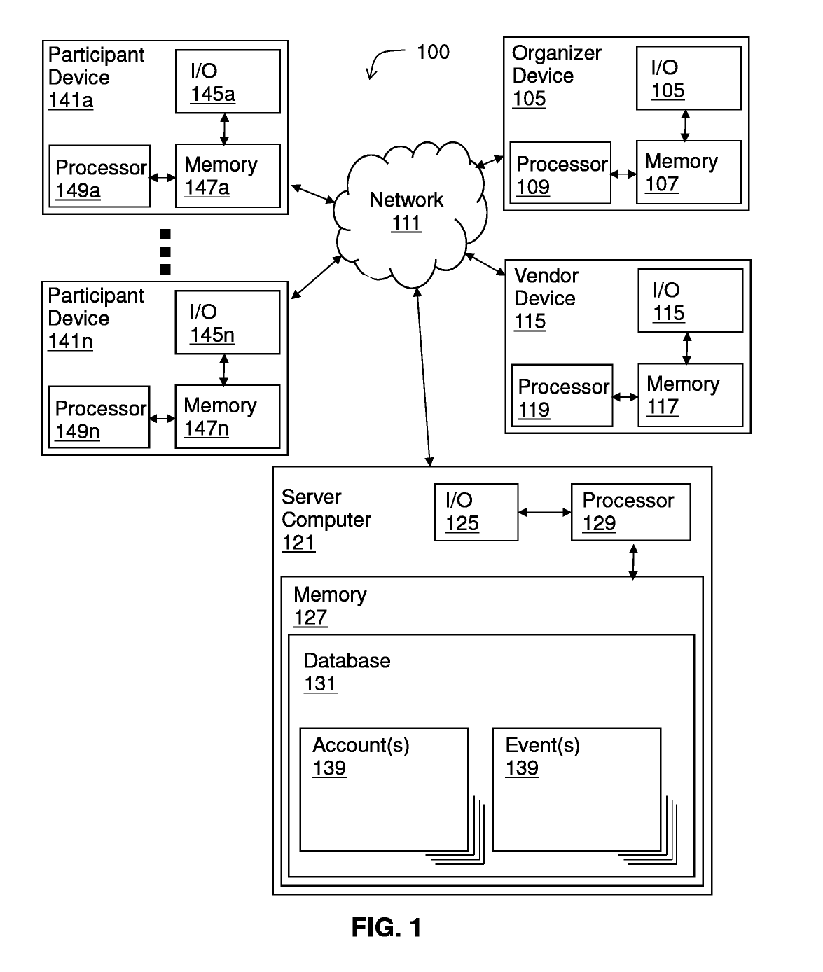

FIG. 1 shows a system 100 for implementing embodiments of the invention. System 100 includes organizer device 105 which can be, for example, a computer (e.g., PC or Mac) or portable electronic device (e.g., tablet or smart phone). Organizer device 105 generally includes processor 109 coupled to memory 107 and input/output mechanism 105. Input/output mechanism 105 can include, for example, keyboard, monitor, mouse, touch screen, network card, or a combination thereof. Organizer device 105 is configured to communication with any other device such as any of participant device 141a, . . . ,141n or server computer 121 via network 111. Network 111 can include components or functionality provided by a cell network (e.g., 3G or 4G, WAN (e.g., the internet), LAN, local Wi-Fi network, direct data transfer (e.g., via USB, infrared or other), or a combination thereof.

While participant device 141a, . . . ,141n and organizer device 105 are depicted as separate entities, embodiments of the invention do not require a distinction between participant and organizer. Any one member can function as or become the other, and roles that characterize either can be shared among such people. Each of participant device 141a, . . . ,141n generally includes one of processor 149a, . . . ,149n coupled to one of memory 147a, . . . ,147n and input/output mechanism 145a, . . . ,145n. Similarly, where server computer 121 is included in certain embodiments, server computer 121 generally includes at least one processor 129 coupled to memory 127 and input/output mechanism 125. Generally, server computer 121 may have, stored in memory 127, a database 131 which can store accounts 139 (for example, with payment information relating to organizer people or participant people) or records including information about events 139.

In certain embodiments, a vendor such as, for example, a restaurant or a ticket sales agency, is a participant in systems and methods of the invention. For example, a restaurant bill or ticket cost allocation information can be provided by a vendor as a digital file that is transmitted via network 111 and, for example, saved in one of memory 107, memory 147, or memory 127. Accordingly, system 100 optionally includes a vendor device 115, which includes processor 119 coupled to memory 117 and input/output mechanism 115.

Systems and methods of the invention provide value by collecting rich data regarding consumer transactions, interests (based on event participation), etc. It is also very interesting that initially this service might appeal to consumers in their 20 to 30's who have not yet been tied down by other obligations such as career, family, possessions that need attention (grass mowed, house painted, etc.). In other words, they have discretionary income and the energy/desire to attend group events. Collecting rich data from a demographic group that has 40 to 50 years of purchasing in front of them could be very valuable. Further, the service will be useful for other age groups or demographic groups.

Such a service further provides systems and methods for aggregating valuable consumer data. Consumer data can be aggregated and organized according to markers and axes to provide valuable data for marketing, advertising, and the provision of enriched or personalized services. For example, targeted ads based on a profile developed over time from each consumers' activities can be shown.

Systems and methods of the invention provide platforms for e-Commerce and advertising to participants. Specific marketing programs based on past purchases and consumer behavior is possible, for example, with the vendor offering discounts and participation fees to the company. The web based and mobile site platforms can provide vehicles for advertising to specific groups or as a total community. In some embodiments, participants may browse the website for suggested events based on their past purchases and likes.

Through the use of the service, a leader does not have to bear an entire cost burden up front. In certain embodiments, at no point does any one member have to bear the entire cost of an event.

In certain aspects, the invention provides methods that include providing an invitation to an event or a shared purchase. Attendees are invited and a financial commitment from them is received. Methods include acquiring a good or service or a commitment or obligation to provide a good or a service (tickets, shared purchase). According to methods of the invention, participants agree on cost allocation before or during arranging for payment or agree to accept cost allocation according to some formula or schema. Collaborative payment is discussed in U.S. Pat. No. 7,343,335; U.S. Pub. 2010/0121745; US. Pub. 2010/0030578; and U.S. Pub. 2002/0103753, the contents of which are incorporated by reference in their entirety for all purposes.

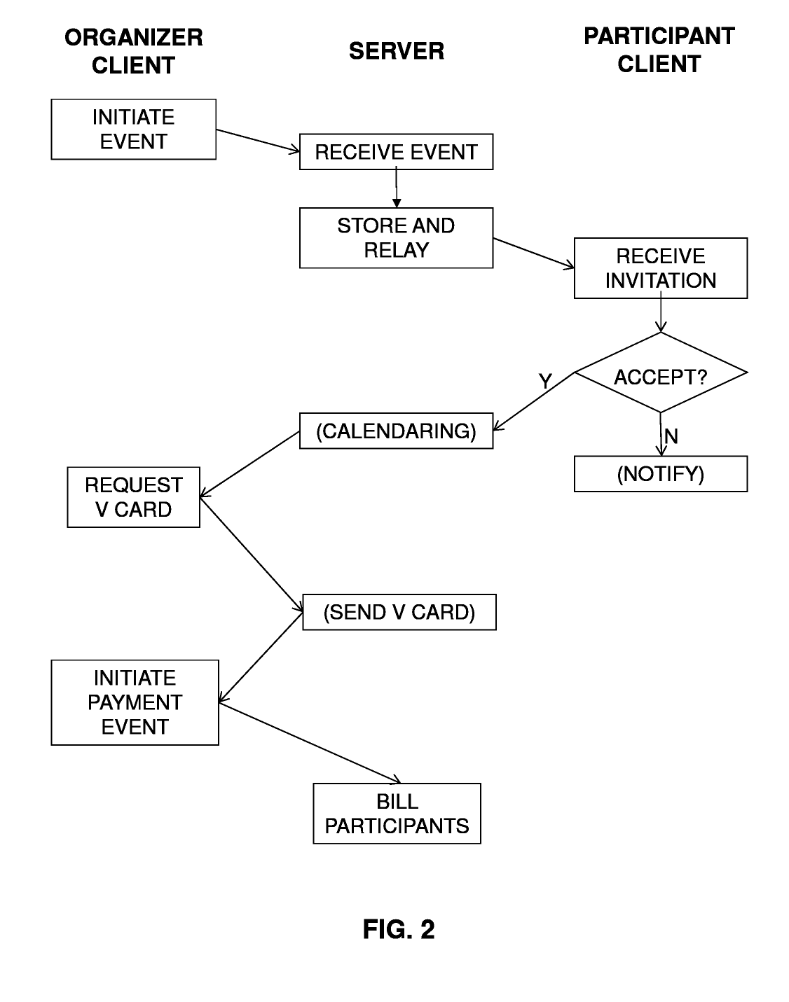

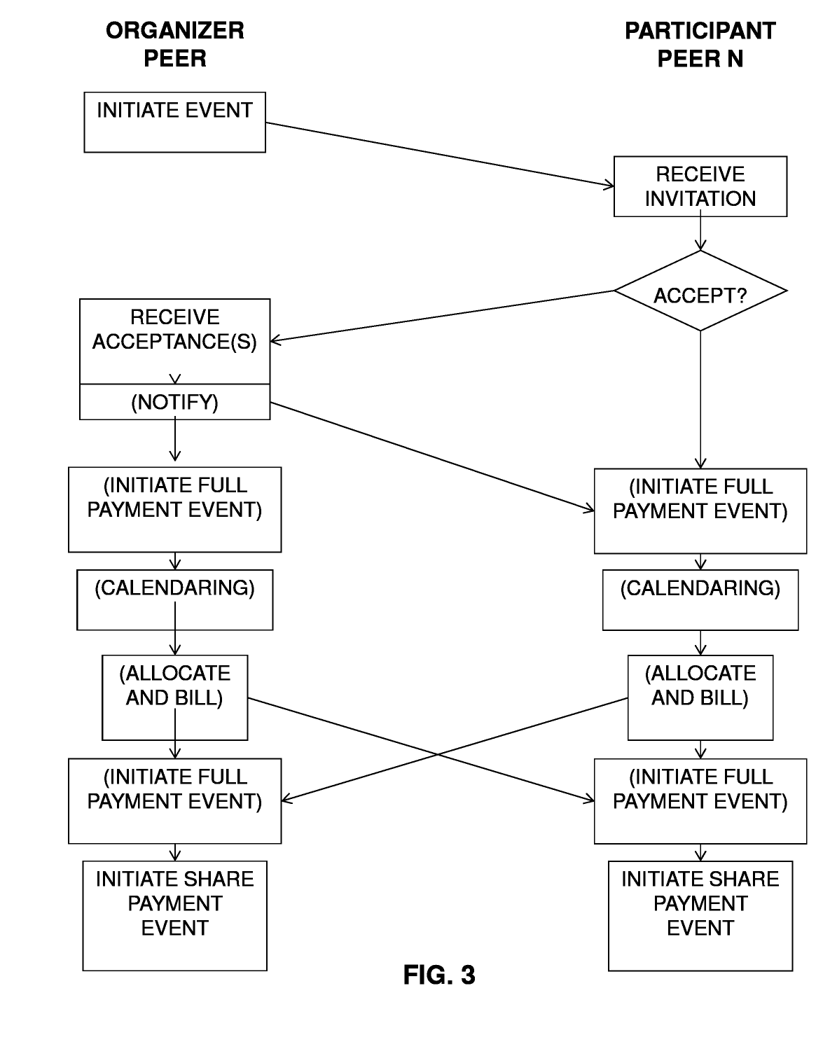

FIG. 2 is a diagram relating to server-based embodiments of methods of the invention. In FIG. 2 and FIG. 3, an idealized time axis runs down the figure and a text label in parenthesis indicates a step that is optional to illustrated embodiments. An organizer client device is used to initiate an event and information is passed to, and received at, a server. The server stores the information and relays it to one or more of a participant. A participant uses a participant client device to receive the information (e.g., as an invitation) and indicate whether they accept it. When the person declines, an organizer or other participants are optionally notified.

Upon acceptance, a server may optionally initiate full payment for the event and any calendaring function. For example, in certain embodiments, the server digitally initiates the appearance of an event reminder on digital calendars of any participants (remembering that an organizer may also be a participant). The server allocates costs according to formula and schema and “bills” participants. In some embodiments, the event leader uses a V card to make a purchase and all participants are billed substantially simultaneously. Billing, here, generally means indicating to a participant that their allocated cost should be paid. Any participant may then initiate a share payment event, which act generally includes initiating payment for their allocated share of the cost. In certain embodiments, the server initiates full payment (e.g., to the vendor) of the event cost after each participant has initiated a share payment event.

The invention provides a system that facilitates the organization and cost allocation of group events or any form of cost sharing between two or more people or entities. Systems and methods of the invention relate to ticket sales, housing rentals, monthly recurring costs, restaurant and entertainment. Examples range from a group of couples going out to dinner and a show, to an office group sharing the cost of a lotto ticket, to a small group of college friends agreeing to split season tickets to the local NFL team or any other activity that involves multiple participants sharing costs.

In certain embodiments, systems and methods of the invention further provide tools for coordinating events. For example, beyond just allocation costs or coordinating payments, a computer system can offer management and coordination functionality for multi-stage or multi-part events. A user can store multiple discrete events in an event file 139 through the use of calendaring functionality. Organizers or participants can access the calendar, propose changes, accept proposed changes, add sub-events, etc., all of which may optionally be stored in database 131 in memory 127 (or, in some embodiments, in one or more of memory 147a, . . . ,147n and memory 107). Event coordination and calendaring can include scheduling variables such as departure and arrival times, time spent together at various locations, cost, etc. Event coordination is discussed in U.S. Pub. 2006/0206363, the contents of which are incorporated by reference in their entirety for all purposes.

As shown, for example, in FIGS. 2 and 3, the activity may commence with an event leader (i.e., “organizer”) inviting potential participants to attend a specified event with a range of dates and costs or to share the cost of a purchase. There may be a minimum and maximum obligation amount determined by upper and lower limits of participants, total costs, or both. The obligation may also be determined on a percentage basis. Acceptance of the invitation by the individual invitees can include making a financial commitment to share their portion of the cost.

In some embodiments, an entity that provides or operates systems and methods of the invention does not make a purchase and has no liability. Cost allocation is pre-determined prior to the request by the leader for the issuance of the V card to acquire the good or services. As shown in FIG. 2 (where parentheses indicate an optional step), systems of the invention can participate in generating or sending a V card. In certain embodiments, an event leader obtains V card information through independent third-party services, systems of the invention, or a combination thereof.

In some embodiments, the invention provides a system in which acceptance by any participant also includes accepting pro rata responsibility for any invitees that accepted the invitation but failed to pay.

In certain embodiments, the purchase can be made by the service and the total cost allocated amongst the participants. Participants can then be required to reimburse the service at cost plus small convenience fee. Performance may be web or mobile based allowing for greater applicability. Systems and methods of the invention can be implemented via certain social media functionality traditionally associated with web 2.0 applications including, but not limited to, interface to third party sites, favorites lists, calendars and reminders.

FIG. 3 gives a diagram relating to peer-to-peer methods of coordinating participation in and payment for an event. Peer-to-peer methods are suited for implementation through the use, for example, of mobile apps which may be operated on handheld portable electronic devices such as phones. As shown in FIG. 3, an organizer initiates an event via their device, causing a participant to receive an invitation. Acceptance can trigger receipt, at the organizer's device, of the acceptance and optionally notification of any participant of acceptance information (e.g., message “all 7 members have accepted”). At least one device may initiate full payment, perform optional calendaring functions, or allocate costs. In some embodiments, one participant or the event leader may “bill” various participants. In certain embodiments, each participant initiates a share payment event, for example, by using one of participant device 141a, . . . ,141n and organizer device 105.

A peer-to-peer implementation of methods of the invention can be flexibly customized according to suitable rules and user preferences. Accordingly, there are not necessarily strict requirements about which user device initiates full payment (noting that initiating full payment can include a payment transaction that is executed extrinsically where, for example, the initiation step includes displaying a message to a user “pay now”) or which device allocates costs.

In certain embodiments, the invention provides systems and methods for event coordination implemented according to a peer-to-peer schema in which only an event leader can submit an event. In such embodiments, the event leader proceeds to pay using, for example, a V card.

In various embodiments, the timing of steps of methods according to various embodiments will vary as circumstances indicate. In some embodiments, an event is initiated through the use of systems and methods of the invention after a corresponding real-life happening. For example, after a check arrives at a restaurant table, a user may initiate an event according to methods of the invention. In certain embodiments, some or all steps (e.g., as shown in FIG. 2 or 3) are performed prior to a corresponding real life happening (e.g., buying plane tickets).

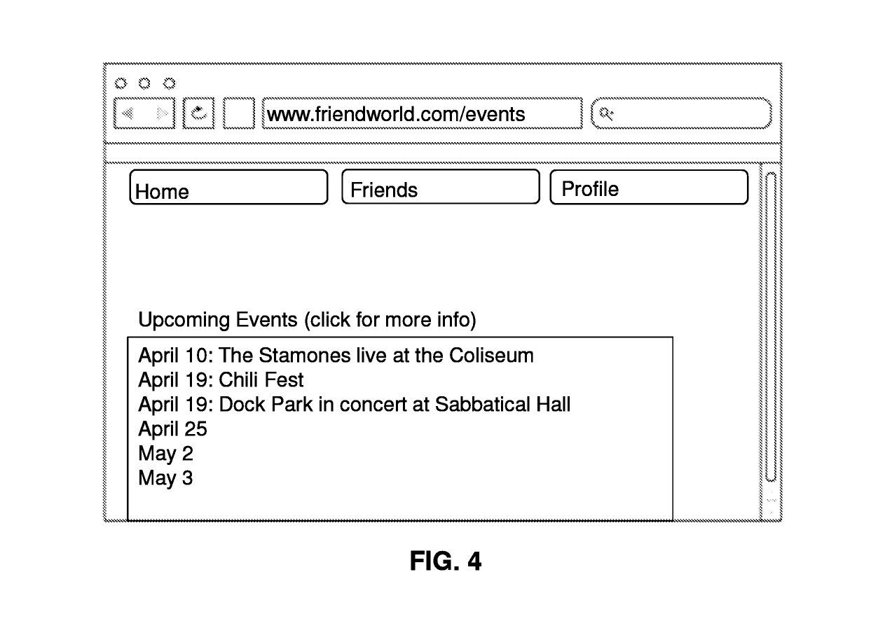

In certain embodiments, systems and methods of the invention include web-based tools. FIG. 4 is a sketch illustrating how an event may be initiated through the use of a web page such as a social networking page. A user may be logged into their social networking account and see information about a real life event (or enter information about a real life event) and initiate an event according to system and methods of the invention.

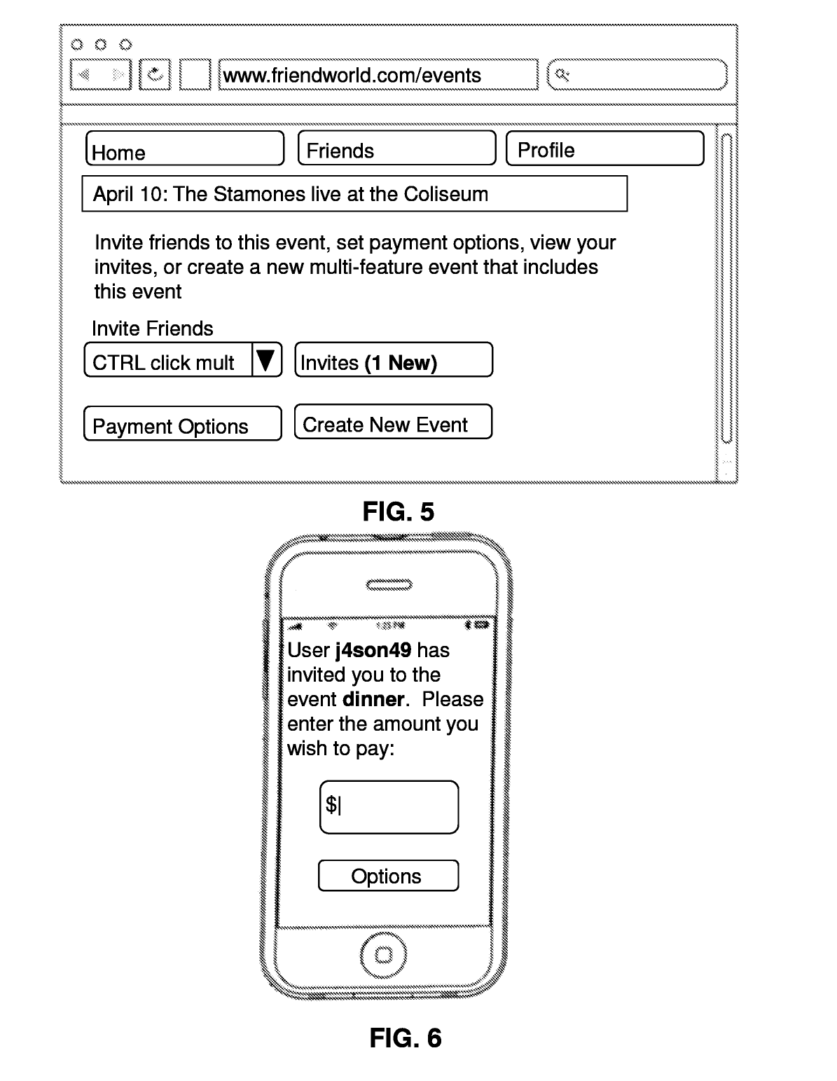

FIG. 5 shows an exemplary display screen according to certain embodiments of the invention for initiating an event or coordinating participation or payment. As shown in FIG. 5, information on the screen relates to a chosen event (here, a concert by the hypothetical musical group ‘The Stamones’). From this screen, a user may invite participants (i.e., “friends”), provide a payment schema or formula (e.g., pro rata), or create a new event.

FIG. 6 illustrates a facet of systems and methods of the invention as it may be implemented via a portable electronic device. As shown in FIG. 6, a participant has received a notification regarding an event labeled “dinner” through input/output device 145a, . . . ,145n or input/output device 105, which may be a display of a smartphone. The display includes “buttons” (e.g., sensitized regions of a touch screen) and text entry fields, which can be provided by standard graphic user interface elements. FIG. 6 generally shows an “open loop” system in that a participant makes full use of systems and methods of the invention through interaction only with their own (e.g., private) electronic device. In illustrated embodiments, there is no need for customers to interact with a merchant device. After viewing the bill and creating or accepting an event, each individual user may simply enter in the amount that they are willing to be charged for their individual dinner. After everyone has entered their proportionate cost, the event leader will submit the event and be provided with the V Card. The event leader may then read the V Card number to the waiter/waitress so they may enter it in their regular processor for payment and all parties will be charged.

In some embodiments, a user device presents an itemized bill by which a user may allocate an item cost to themselves or refuse an item cost. In vender-involved embodiments, the check data may be transmitted to the phone from, for example, vendor device 115. In certain embodiments (e.g., certain open loop embodiments), the check data is obtained to initiate the event by using a camera built into the phone to take a picture of a paper check. The obtained image is analyzed by optical character recognition and data processing and bill items and their prices are stored (e.g., in a digital file or variable in one of memory 147a, . . . ,147n or memory 107) and presented to a user.

Aspects of the invention provide systems and methods that include vendors allocating the cost (offered, invoiced, or collected) of products, services, or offers that are provided for consumers. Systems and methods for allocating any of offers, billing, collections, or a combination thereof (“a cost”) can include matching an interest of a consumer to an offer that includes components associated with different vendors and a cost. Preferably, each vendor may commit to providing to the consumer a good or a service indicated by their associated component. Systems and methods include allocating the cost among the vendors.

For example, a consumer expresses interest in a 7 night stay in Rome. A hotel might respond with a multi-vendor offer wherein they team up with a restaurant, a tour guide, a limo service, etc. to make a multi-vendor, complex offer to the consumer and use systems and methods of the invention to allocate the funds coming from the consumer.

A tool by which vendors may allocate costs associated with an offer is provided that may manage offers and facilitate transactions among consumers and merchants. The vendor cost allocation tool can also provide merchants a third-party service of managing life-cycle of offers. The vendor cost allocation tool can also incorporate communities to support community-wide interests and offers. Other embodiments are within the scope of the invention.

In some embodiments, a consumer has an account within which to receive offers such as, for example, an online profile account within a dedicated service (e.g., on a website named OfferSafe). Such an account can provide a service of receive and storing offers, relaying those offers to consumers, and holding offers in a secure location for the consumer to consider and possibly later redeem. Such a service preferably provide systems and methods that include storing a consumer-created account that indicates a willingness to receive offers; receiving interests from the consumer chosen from a taxonomy hierarchy, each interest preferably defining a category including numerous products and/or services; receiving an offer from vendors; and simulating matching the offer to one of the interests. Systems and methods may additionally include receiving a modified offer and matching it with the interest, then distributing the matched offer to the consumer and storing the offer for use at a later time. Offers here in general are not advertisements in that any one or more of the following may apply: an offer can include products or services at a price or with terms tailored uniquely to an intended recipient; an offer can be styled as an offer by one or more vendors with the intention that acceptance by a consumer is binding; an offer can be non-advertised, and efforts may be made to keep it a private communication between vendor(s) and consumer; being in possession of the offer itself may be the only way by which a consumer may avail of the benefits; etc. In certain embodiments, a consumer receives an offer without strictly the offer being presented within or stored within a dedicated online account (e.g., via email or mail).

Use of a dedicated offer storage account (online or elsewhere), hereinafter called an OfferSafe, may provide desirable benefits. The OfferSafe can be used if the consumer makes a purchase or needs to update interests of its own. The OfferSafe is preferably a logical file, and can be hosted by the vendor cost allocation tool. Alternatively, the OfferSafe can be downloaded and reside on a computer of the consumer. For the latter case, contents of one or more instances of the OfferSafe can be synchronized.

To deploy an offer, each vender preferably contributes a component to an offer campaign. The offer campaign is preferably a campaign of an offer provisioned by one or more of the vendors, and can be hosted by the vendor cost allocation tool (e.g., the service providing OfferSafe). An offer campaign may include information about one or more associated offer, any effective or expiration date of the offer, any fulfillments that can be associated with the purchase of the offer, and any date-dependent variations. One example of a date-dependent variation is “10% off in the first week, 20% off in the second week, then 30% off in the third week.”

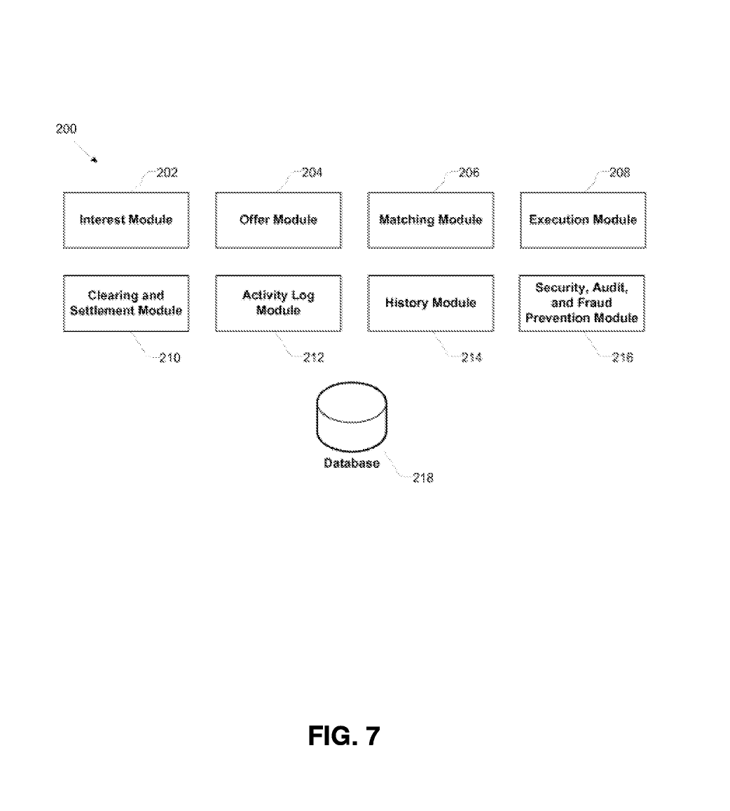

FIG. 7 gives a schematic of a vendor cost allocation tool according to certain embodiments. The vendor cost allocation tool preferably includes an Interest Module 202, an Offer Module 204, a Matching Module 206, an Execution Module 208, a Clearing and Settlement Module 210, an Activity Log Module 212, a History Module 214, and a Security, Audit, and Fraud Prevention Module 216. The vendor cost allocation tool can also be connected to a Database 218. The Database 218 can be included within the vendor cost allocation tool, or can be located remotely (e.g., across a network and operated by a third party) from the vendor cost allocation tool. While FIG. 7 shows vendor cost allocation tool as including each of the described modules, one or more of the modules can be omitted in certain configurations. Also, while each of the modules are shown as separate functional blocks in FIG. 7, the functionality provided by each can be combined into a single functional, or logical unit (e.g., the Interest Module 202 and the Offer Module 204 can be combined into a single module). Furthermore, the modules shown in FIG. 7 can be hosted or otherwise provided by a single computer (e.g., a single server) or using multiple computers (e.g., using a cloud configuration). The Interest Module 202 can be configured to manage interests of the consumer. Preferably, the consumer can provide a list of interests to the Interest Module 202 that can be used by vendors to generate offers that the consumer would like to receive.

The Offer Module 204 can be configured to manage offers of vendors. Preferably, vendors can provide information to the Offer Module 204 relating to one or more offers that it intends to make to consumers. Information can include, for example, the subject matter of the offer (e.g., luxury hotels, clothing, cars, etc.), and other information that can be used by the Matching Module 206 to match relevant offers with consumers that wish to receive such offers. The Matching Module 206 can be configured to perform the matching of offers to interests. The Matching Module 206 can be configured to match offers from vendors with consumers that have indicated a willingness to receive such offers. When vendors contribute to offers through the Offer Module 204, the vendors can indicate a set of interest phrases that should be matched to the interests specified by consumers. Consumers can specify interests through the Interest Module 202 either by using the taxonomy hierarchy or by specifying a set of keywords.

Interests can be logically stored in the OfferSafes of the consumers and/or can be physically stored in the Database 218. A matching engine can be configured to match the interest phrases associated with an offer with the interests specified by consumers. A match is preferably found based on a set of rules. One exemplary rule can be that there must be an exact match between interest phrases of an offer and an interest of a consumer. Another exemplary rule can be that there must be a match between interest phrases of an offer and a portion of an interest of a consumer while the interest can have other non-matching terms. The matches are preferably recorded. The Matching Module 206 can preferably associate an instance of the matched offer with the OfferSafe of the matched consumer. In addition, the matching engine can report to vendors the set or a summary of the set of consumer interests that have matched the offers of vendors. The Matching Module 206 can be configured to find matches for different sets of offers and Interests. In one example, the matching engine can be configured to find matches for all offers and interests. In another example, the matching engine can be configured to find matches for all interests and a subset of offers. This can be useful if vendors wants to understand how many matches will be triggered by different interests with only active offers. Consumers can define interests but keep certain interests inactive for matching. The Offer Execution Module 208 can be configured to execute a transaction between the consumer and vendors. In one embodiment, the Offer Execution Module 208 can transfer control to the website of vendors, passing to vendors information required by vendors to execute the purchase associated with the offer. Once the purchase transaction actually takes place, the Offer Execution Module 208 can then receive the information about the purchase transaction from vendors. This information can then be processed by the Clearing and Settlement Module 210. This information is also preferably stored in the OfferSafe account of the consumer. In another embodiment, the Offer Execution Module 208 can transfer control to the website of vendors, passing to vendors information required by vendors to assist the purchase transaction. The website of vendors can then pass the same information and any additional information back to the Offer Execution Module 208, which can ensure that all conditions of the offer are met and then instruct the website of vendors to complete the purchase transaction. Alternatively, the Offer Execution Module 208 can execute the purchase transaction then send the purchase information to vendors to fulfill the purchase. Once the purchase transaction actually takes place, the information about the purchase transaction can be processed by the Clearing and Settlement Module 210. This information is also preferably stored in the OfferSafe account of the consumer. Once a purchase transaction occurs, the Offer Execution Module 208 can proceed to process the fulfillment part of the offer, if one exists, either automatically or upon a request from the consumer. The Offer Execution Module 208 can send the information required to execute the fulfillment to the same merchant, another merchant, and/or a third-party. The execution mechanism of a fulfillment transaction is similar to that of a purchase transaction. The Offer Execution Module 208 can manage all steps during the fulfillment transaction. Once the fulfillment transaction takes place, the information about the fulfillment transaction can be processed by the Clearing and account of the consumer. There can be more than one communication mechanism via which various merchants and various modules of the vendor cost allocation tool communicate to each other during executions or other phrases of transactions. One example is via web service calls between one or more of the vendors and the Offer Execution Module 208.

The Clearing and Settlement Module 210 can be configured to clear and settle transactions between, for example, vendors, communities, third parties, and consumers. Each instance of an offer can be associated with information about the fees or commissions due to any communities, third parties, other merchants and/or consumers. The Clearing and Settling Module 210 can process all new purchase transactions and fulfillment transactions, aggregate the information, and notify the appropriate parties such information as what is owed and to which party. The information can be in an aggregate format or in details or both. The Clearing and Settling Module 210 can also keep track of any funds received and any outstanding balances.

The Activity Log Module 212 can be configured to record information relating to activities and interactions of parties, such as the consumer, the Community 120, vendors, and the OfferSafe 300. For example, the Activity Log Module 212 can be configured to log timestamps and durations of consumer logons, when and how the interests of the consumer were updated, the links that the consumer clicks, the time that the consumer spends visiting a particular offer, purchase or fulfillment activities, etc. Preferably, the Activity Log Module 212 records all consumer activities and responses at a substantially detailed level so that the records can support the needs of potential future analysis.

The activity logs can then preferably be utilized by the History Module 214 to provide a wide range of business intelligence, such as consumer habits and offer performances, etc. The History Module 214 can be configured to keep track of matching and other transaction history. Preferably, the History Module 214 can aggregate, organize and process information in activity logs, which can be stored in the Database 218. The processed information can also be stored in the Database 218. The History Module 214 can provide a flexible mechanism to create alerts and reports, preferably structured and processed information, the History Module 214 can provide important business intelligence to merchants, communities, and even consumers. For example, this information can include a complete behavioral record of the consumer. This information can allow vendors to target offers to certain behaviors, for example, to send offers only to consumers who have purchased goods within the last six months, not to generate offers with fulfillment discount percentages greater than the discount levels to which the consumer has already responded, or only to send offers to consumers who have clicked through an offer. The History Module 214 can also provide reports and overall metrics to measure the activity and success level of merchants and communities.

The Security, Auditing, and Fraud Prevention Module 216 can be configured to monitor transaction security, to support auditing, and to prevent potential frauds through a number of processes. For example, the Security, Auditing, and Fraud Prevention Module 216 can utilize digital signature techniques on information and records stored in the Database 218 (e.g., the activity logs) to help reveal any tampering. In addition, the Security, Auditing, and Fraud Prevention Module 216 can access activity logs and other information in the History Module 214 to produce signed and encrypted reports to validate transaction flows and ensure non-repudiation. The Security, Auditing, and Fraud Prevention Module 216 can use various algorithms to analyze activity logs and/or history logs to identify fraudulent activities, for example, misuse of an OfferSafe ID, merchant/consumer conspiracies, or purchase return scams.

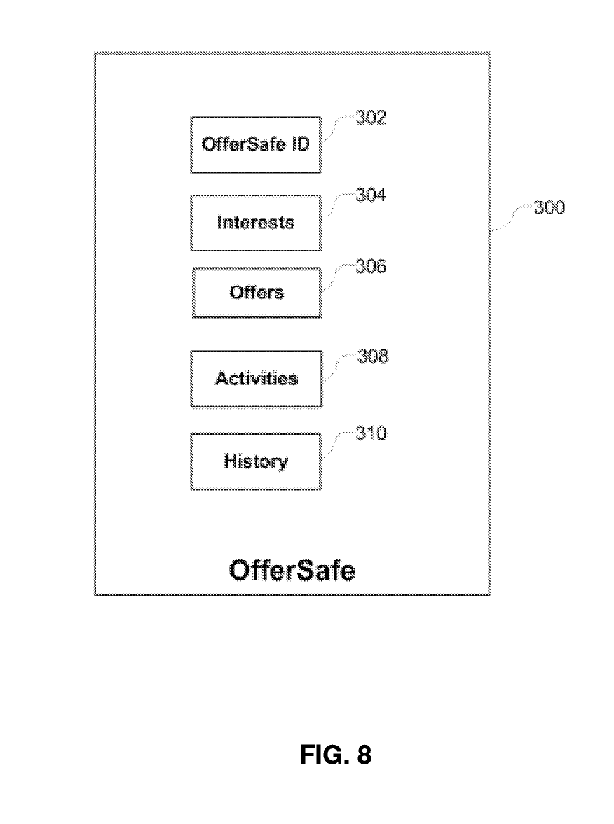

FIG. 8 shows an exemplary structure for an OfferSafe 300. OfferSafe 300 can be implemented using a logical file that corresponds to the consumer, although other techniques are possible. The OfferSafe 300 can reside on a consumer device 105 (e.g., a home PC of the consumer) or remotely in a central database (e.g., the Database 218). The OfferSafe 300 can preferably include numerous pieces of information corresponding to the consumer. For example, the OfferSafe 300 can include an OfferSafe ID 302, Interests 304, and Offers 306, Activities 308, and History 310. Preferably, the OfferSafe 300 is accessible by the vendor cost allocation tool. The ID is preferably a unique identifier. The unique identifier can be, for example, generated by the vendor cost allocation tool, or generated by the consumer. The Interests 304 can include one or more interests that are defined by the consumer. While the structure of the information included in the Interests 304 is discussed in more detail below, the Interests 304 can include, for example, information that can be used to identify offers that the consumer is interested in. The Interests 304 can be a list of information such as luxury hotels, ski jackets, horses, cashmere sweaters, and cars.

By defining interests in the OfferSafe 300, the consumer can opt in to receive related, multi-part offers from vendors. For example, if “luxury hotels” is one interest saved by the consumer, the consumer can be matched with offers relating to travel packages that include the Ritz Carlton or Mandarin Oriental hotels. The consumer can later add, change, and remove interests in the OfferSafe 300. The Offers 306 can include one or more instances of offers that have been matched to the consumer using, for example, the information contained in the Interests 304. While the structure of the information included in the Offers 306 is discussed in more detail below, the Offers 306 can include instances of offers that have been matched with the consumer using the information contained in the Interests 304. For example, the Offers 306 can include instances of offers for discounted nights at a luxury hotel. The Activities 308 can include a record of all current and active activities and transactions. For example, the Activities 308 can present the state of a purchase transaction or a fulfillment transaction, including information such as when the purchase or the fulfillment is expected to be shipped or completed. The Activities 308 can also contain any messages and dialogues (e.g., about dispute resolution) that the consumer has with vendors. The Activities 308 of the OfferSafe 300 is preferably only associated with the OfferSafe ID 302 so that the consumer can remain anonymous. The History 310 can include a record of some or all transactions of the consumer, for example, offers that have been executed or fulfillments that have been received.

Optionally, the OfferSafe 300 can be configured such that it does not contain personal information corresponding to the consumer, nor, preferably, is such personal information required to create the OfferSafe 300. In certain embodiments, vendors have no knowledge of the identity, or other personally identifiable information, relating to the consumer. For example, preferably the OfferSafe 300 does not include information such as name, address, phone number, or email address. The consumer can remain completely anonymous to vendors before the consumer actually makes a purchase through vendors. When the consumer makes a purchase through the vendor cost allocation tool, the vendor cost allocation tool can utilize mechanisms, such as a single-use credit card number (i.e., a V card) or a third-party freight forwarder, to maintain anonymity of the consumer.

As shown in FIG. 8, OfferSafe 300 includes at least one interest 304. In some embodiments, interest 304 is represented using a taxonomy hierarchy called an Interest Universe. To illustrate, an interest may indicate that the consumer is interested in the product of t-shirts with facets of red color, long sleeve, and cotton fabric, in the product group of women shirts, which is in the interest set of clothing, which is in the marketplace of outdoor apparel. The Interest Universe can be created and maintained by the vendor cost allocation tool. Consumers and merchants preferably cannot directly change the taxonomy hierarchy of an Interest Universe. Each interest in an Interest Universe has a unique Interest ID and is preferably immutable for tracking and reporting purpose. In certain situations, however, the vendor cost allocation tool can expand the Interest Universe based on the input from consumers or merchants to improve system performance and address growing needs of consumers or merchants. This taxonomy hierarchy of an Interest Universe can permit interest generality and specificity. For example, an interest can on one hand be broad and general, e.g., “women shirts,” or on the other hand be narrow and specific, e.g., “women shirts t-shirts−>cotton, long-sleeve, red, V-shape. Alternatively, the consumer can specify interests using a set of keywords, for example “National equestrian championship 2009” or “Civil war battlefield tour.” An interest can be represented as a set of keywords with the same syntax used in search engines. Interests can be specified or modified in many ways, such as input forms, speech recognition, and guiding wizards.

The vendor cost allocation tool can use a set of rules to determine whether the description of a particular offer is a match for the interest keywords of a particular consumer. These rules include, for example, 1) taking into account grammar considerations such as synonyms and plurals; 2) the historical activity of all and each consumer; and 3) heuristics that reveal an indirect match.

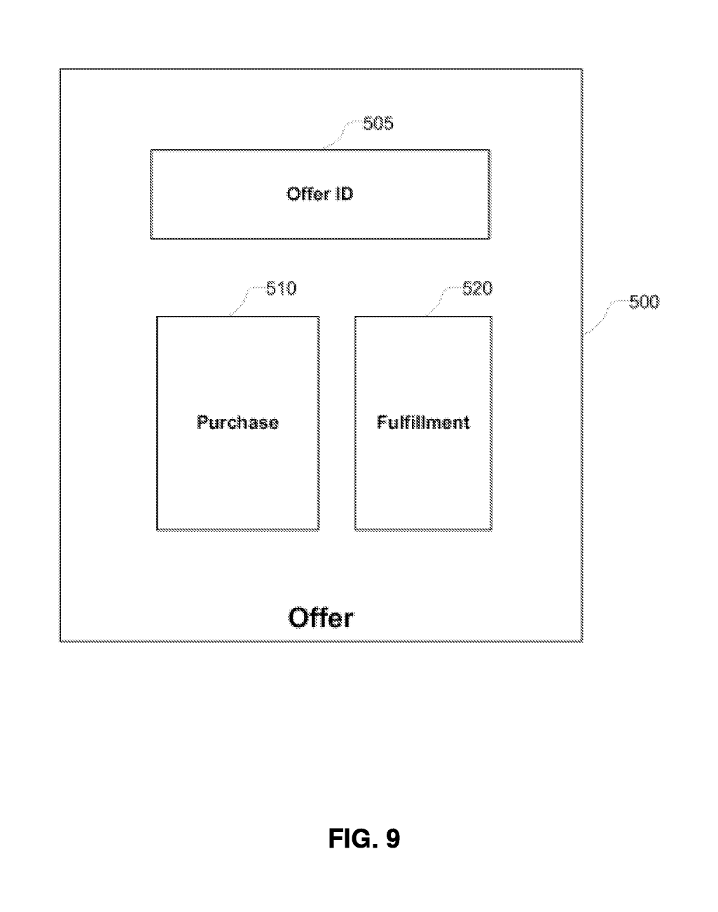

FIG. 9 describes an exemplary logical structure of an Offer 500. An Offer 500 can have an Offer ID 505. The Offer ID 505 can be a unique identifier that can be, for example, generated by the vendor cost allocation tool, or generated by vendors. The Offer 500 can also have distinct components: one or more Purchase 510 and one or more Fulfillment 520. The Purchase 510 involves the purchase of a goods or service (e.g., a television).

The Fulfillment 520 involves a reward given to the consumer based on the purchase (e.g., a free DVD player in return for buying the television). Separating the Offer 500 into two distinct logical components can allow the creation of complex and feature-rich multi-part offers. For example, the purchase can be performed by one merchant while the fulfillment is executed by another merchant. Use of the cost allocation tool allows merchants to participate cooperatively to present a unified offer to the consumer. In some situations, a fulfillment can itself be an offer from another merchant (i.e., another component of an offer). This permits creation of multistep, multi-party offers.

In addition, the Purchase 510 of the Offer 500 can be associated with multiple different Fulfillments 520. Once the Offer 500 is matched to an interest, an instance of the Offer 500 is distributed to the OfferSafe. Each instance of the Offer 500 can be distinct and can have its own unique Offer Instance ID. Within each instance of the Offer 500, a purchase can be associated with zero or more fulfillments; a fulfillment can be associated with zero or more purchases.

The vendor cost allocation tool can be configured to deliver a multi-component offer to each matched consumer. For example, a multi-component offer can be based on one or more factors such as the consumer's stated preferences and actual incentive behaviors obtained from the consumer's purchase history. Each OfferSafe 300 can contain a record of all the offers sent to the consumer and the consumer's response behavior for those offers. Over time, based on information gleaned from, for example, tracking prior usage, the vendor cost allocation tool can compute which fulfillment type is more likely (e.g., statistically more likely) to result in a sale. For example, one consumer who purchases certain goods may prefer discount coupons on future purchases while another consumer who purchases the same goods may prefer bonus airline frequent flyer mileage. Merchants can use this information to generate more focused offers. As a result, consumers can receive more personalized and user-friendly multi-component offers.

The flexibility of a multi-component offer can make it possible to create and support offers that are difficult for merchants to implement on their own. For example, some categories of offers include:

1) Standard Purchase and Standard Fulfillment: A consumer makes a purchase from a merchant. The vendor cost allocation tool verifies the purchase and allocates costs to the vendors. The reward can be fulfilled by the same merchant that executes the purchase or by a different merchant.

2) Standard Purchase and Carried Fulfillment: Certain fulfillments may related to products and services of one merchant but be borne by a second merchant. For example, a hotel chain may wish to give a consumer a discount on a rental car (e.g., provided by an unrelated company). Thus the hotel chain agrees to carry the cost of the fulfillment and the vendor cost allocation tool receives the hotel chain's commitment to pay.

3) Multi-component offer as joint venture. An offer may include cooperating vendors who may or may not identify as having one leader and one or more subsidiary participants. The vendor cost allocation tool allows the offer to be presented as an offer of equals.

4) Complex structured multi-component offer. An offer may include complex conditionals (e.g., if consumer choose one airline, then hotel chooses auto rental agency that can be discounted); conditionals over time (for as long as consumer is on contract with oil service A, lawn service B will give discount); referral benchmarking (for each new client consumer refers to firm A, companies B and C will offer a service); or a combination thereof. In such cases, the vendor cost allocation tool allocates costs.

5) No purchase and A Fulfillment: In some situations, a transaction only involves the fulfillment of a reward. For example, a consumer has a coupon and goes to the fulfillment merchant site to exercise that coupon. The coupon could be the fulfillment from a previous purchase through a different vendor.

The vendor cost allocation tool can provide vendors a third-party service that can manage the full life cycle of an offer, including purchase, redemption, and fulfillment. An example of the full life-cycle of an offer is as following: 1) A merchant initiates an account with the vendor cost allocation tool by creating the account through a user interface on a computing device. Alternatively, one of the merchants may create an account through some other medium. For example, a merchant can work with an OfferSafe representative via phone, through e-mail, or in person, who then creates the account for the merchant. 2) The merchants provision a multi-part offer as part of an offer campaign through the Offer Module 204 of the vendor cost allocation tool. Provisioning of offers can involve providing necessary information about the offers. This information can be general context information, references to locations and contents on the vendors' web sites, and rendering components for displaying and presenting offers in a user interface. 3) A consumer indicates intent to exercise an offer through vendor cost allocation tool. For example, the consumer may indicate intent to exercise an offer by clicking on a received hyperlink representing the offer. 4) A computer dialogue can ensue among the consumer, one of the vendors, and the vendor cost allocation tool to execute the purchase step of the offer. 5) The vendor cost allocation tool can provide verification of the state of the transaction to the consumer.

Additionally, the vendor cost allocation tools gives a vendor a tool with which to create an offer with components and subsequently to look for other vendors to fulfill individual ones of the components. For example, a lead vendor can create a two component (or more) offer in OfferSafe including products P and Q. The lead vendor can commit to providing P. The lead vendor can then go advertise to secondary vendors the opportunity to provide Q. The lead vendor can recruit a second vendor to fulfill one or more component of the offer. The full, multi-part offer can then be provided to the consumer.

Vendors can preferably use the offer life-cycle management service to create and manage offers without having to make changes or add code to their own websites. This management service can also support offers that are too complicated to be implemented by merchants themselves, such as multi-step, multi-party offers. Alternatively, merchants can completely omit certain products or services from their own websites and use the vendor cost allocation tool as their sole retail fronts for those products or services. Omission of certain products or services from the websites of merchants can help merchants to achieve certain purposes, such as to protect certain brand names or to handle overstocks. In order to provide the offer life-cycle management, it is preferred that unique IDs are assigned to various entities and various instances of entities in the Arrangement 100. Those unique IDs help to allow the vendor cost allocation tool to support detailed tracking of the states of activities and transactions. The detailed tracking helps to resolve any potential issues or disputes. The detailed tracking information and other related records are preferably digitally signed to help to provide authentication and ensure non-tampering.

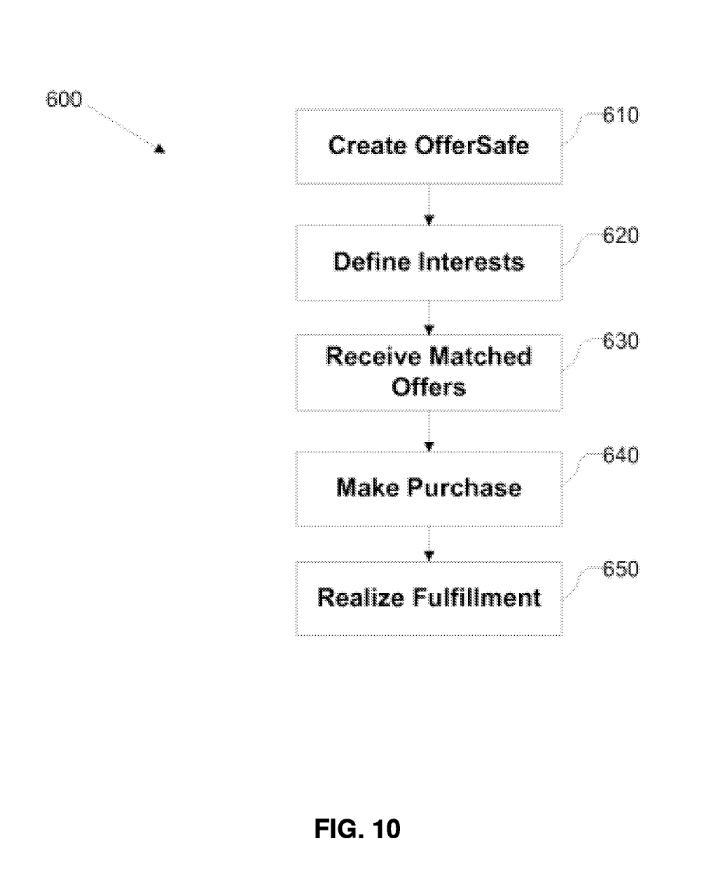

FIG. 10 depicts a method of receiving multi-component offers via a Process 600 using from a consumer's viewpoint by the stages shown. The Process 600, however, is exemplary only and not limiting. The Process 600 can be altered, e.g., by having stages added, removed, modified, or rearranged. At Stage 610, the consumer creates the OfferSafe 300. As mentioned above, the OfferSafe 300 can be created without any personal information of the consumer so that the consumer is able to maintain anonymous. At Stage 620, the consumer can define interests in the OfferSafe 300. The vendor cost allocation tool can provide an intuitive user interface, such as predefined interest forms or guidance wizards, to assist the consumer in defining interests. The vendor cost allocation tool need not require the consumer to download any application to their computing device, although one can be used if preferred. The consumer can select interests based on the taxonomy hierarchy of an Interest Universe or specify interests using a set of keywords. By defining interests, the consumer can opt-in to receive matching multi-component offers from vendors. In some situations, the consumer can reduce the range of merchants from which the consumer would like to receive offers, for example, by limiting to certain brands, by specifying certain demographics limitations, or by restricting eligibility based on certain attributes of merchants. After defining interests, the consumer can preferably add, change, or delete the interests through the vendor cost allocation tool at any time. The consumer can choose to be notified of the matched offers by suitable methods (e.g., e-mail, SMS, text message, phone call, notification icons on a computer desktop, etc.). At Stage 640, the consumer can elect an offer to make a purchase. The consumer can click on a web link of an offer instance to initiate the purchase. The web link can lead the consumer to the storefront website of vendors. The web link is preferably embedded with one or more codes identifying the offer and the offer instance. Based on the embedded codes received, vendors can locate the particular goods or service and start the purchase transaction with the consumer. The embedded codes can represent offers specially targeted or tailored to a particular consumer or community and, thus, may not be available to the general public. The nonpublic feature of offers can allow merchants to tailor offers to focus on certain market segments, without publishing the offers to the general public. Other than transacting with vendors directly, the consumer can alternatively conduct the purchase transaction with the vendor cost allocation tool. In the latter situation, the vendor cost allocation tool can act on behalf of vendors to complete the purchase transaction with the consumer. At Stage 650, the consumer can realize the fulfillment, if any, associated with the purchase. For example, the consumer can receive a free DVD player in connecting with purchasing a television. Similar to the purchase transaction, the fulfillment transaction can be conducted between the consumer and vendors and/or be facilitated by the vendor cost allocation tool.

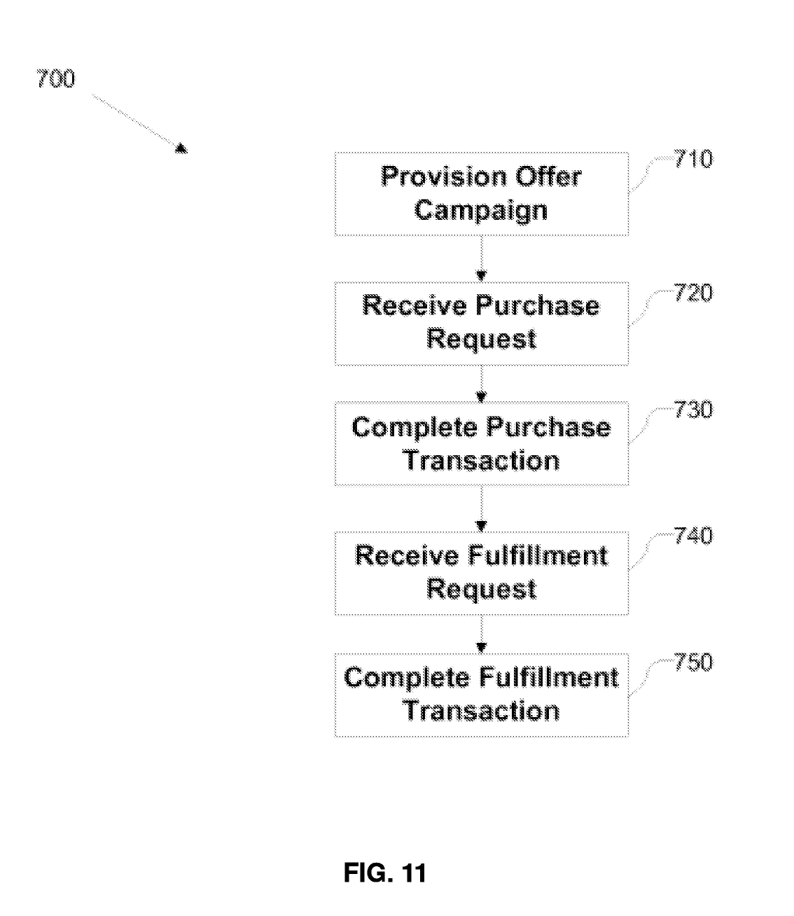

FIG. 11 depicts a Process 700 for cost allocation from a merchant viewpoint. The Process 700, however, is exemplary only and not limiting. The Process 700 can be altered, e.g., by having stages added, removed, modified, or rearranged. At Stage 710, vendors can provision an offer campaign to vendor cost allocation tool. The offer campaign preferably contains one offer and other related information, such as rules and restraints. The rules and restraints can include instructions on how to exercise the associated offer, any effective or expiration date of the offer, any fulfillments that can be associated with the purchase of the offer, and any date-dependent variations. One example of a date-dependent variation is “10% off in the first week, 20% off in the second week, then 30% off in the third week.” In the offer campaign, vendors can determine the distribution of the offer by providing a set of interest phrases or keywords for matching the offer to interests. In addition, vendors can provide additional parameters to further target a sub-set of consumers, for example, by targeting a particular community, by specifying certain demographics limitations, or by restricting eligibility based on consumers' past purchase and fulfillment behaviors. The vendor cost allocation tool can provide merchants with consumer information, such as purchase behaviors, to assist merchants in crafting more effective offers.

Because the consumers are preferably anonymous, preferably no personal information of the consumer, such as name and address, is compromised. The offer campaign can be directed at one or more sets of consumers. For example, the offer campaign can contain several offers that are for the same product or service but targeted to different sub-sets of consumers. For example, the offer campaign can contain a set of fulfillments options that are targeted to certain consumers based on previous incentive behaviors. For example, one consumer may be likely to respond to a fulfillment of discounts; another consumer may be likely to respond to a fulfillment of frequent-flyer mileage points.

To further assist merchants crafting offers, the vendor cost allocation tool, through the Matching Module 206, can provide a mechanism where distribution of offers is simulated. A simulation can yield a complete description and summary information about the subset of consumers who will be receiving the offers. For example, the Matching Module 206 can generate distribution lists and report the simulation result without actually distributing the matched offers to consumers. Distribution lists, which are preferably made up of interest phrases, keywords and/or other additional parameters, can be stored and later reused by merchants. Based on the simulation result, merchants can update parameters of offers to create a more effective offer campaign.

Using the vendor cost allocation tool, vendors can receive a purchase request from the consumer or through the vendor cost allocation tool. The vendors can receive a purchase request in a number of ways. For example, when the consumer clicks through to the website of vendors, information identifying the offer and the offer instance, which can be embedded in URLs, can be transmitted to vendors. In another example, the purchase request can be received through a web service call or through a proxy. Vendors can complete the purchase transaction with the consumer or through the vendor cost allocation tool. The vendors can complete the purchase transaction in a number of ways. For example, the purchase can be done completely at the website of vendors. Once the purchase transaction is completed, information about the purchase transaction can be sent to the OfferSafe to verify that all conditions of the purchase transaction have been met in order to determine whether the consumer is entitled to a fulfillment. Vendors can receive a fulfillment request from consumer or through the vendor cost allocation tool. The fulfillment request can be received in a similar way as the purchase request is received. The fulfillment request can be generated automatically from the vendor cost allocation tool or generated upon the direction of the consumer. In some situations, another merchant (different from the merchant that completes the purchase transaction) can receive the fulfillment request. Fulfillment requests can also be sent to third parties. The vendor cost allocation tool can inform vendors of the receipt of the fulfillment request and the state of fulfillment transaction.

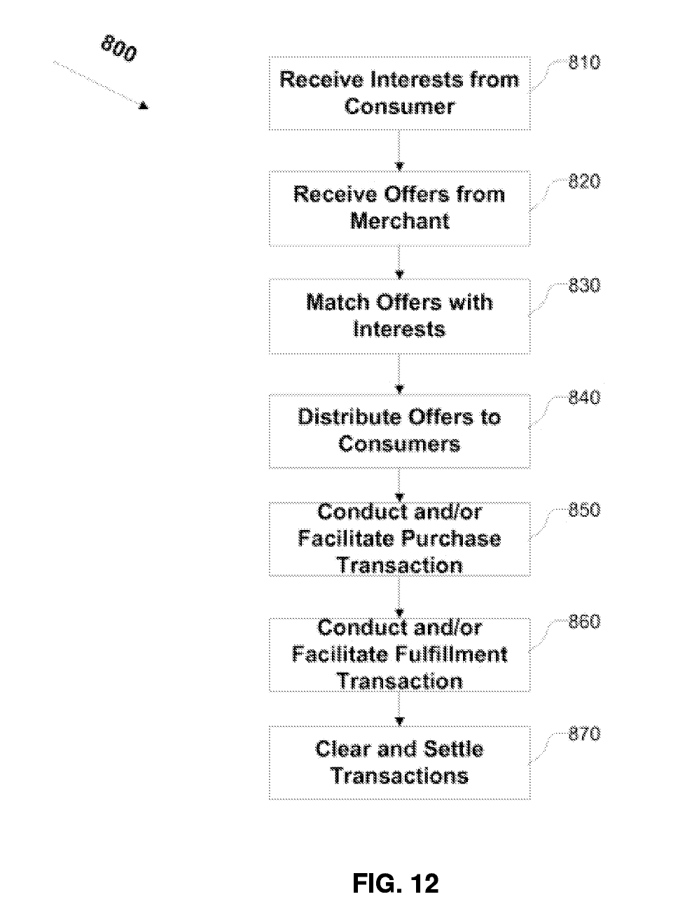

Referring to FIG. 12, a Process 800 from the viewpoint of the vendor cost allocation tool includes the stages shown. The Process 800, however, is exemplary only and not limiting. The Process 800 can be altered, e.g., by having stages added, removed, modified, or rearranged. At Stage 810, the vendor cost allocation tool can receive interests from the consumer. The interests can be in the format of the taxonomy hierarchy of an Interest Universe or in the format of a set of keywords. The interests can be maintained and stored by the Interest Module 202 (see FIG. 7). At Stage 820, the vendor cost allocation tool can receive offers from vendors. The offers can be part of some offer campaigns. The offers can be matched to the taxonomy hierarchy of the Interest Universe or be specified in the format of a set of keywords. The offers can be maintained and stored by the Offer Module 204. In some situations, offers and information associated with offers can be internally represented by a proprietary offer language. Offers such as multi-component offers are matched to interests. The matching can be performed by the Matching Module 206. The matching can be scheduled to run at predetermined times, e.g., every day. The predetermined times can also be specified by the consumer, vendors, or the vendor cost allocation tool. The matching can also be automatically triggered by other events, such as the consumer adding or updating interests, vendors provisioning new offers, etc. In addition, the consumer or vendors can manually initiate a matching request. At Stage 840, the vendor cost allocation tool can distribute instances of the matched offers to the consumers having corresponding interests. The instances of the matched offers can be actively presented to the consumer when the consumer logs in to the OfferSafe account. In addition, the instances of the matched offers can also be sent to the consumer individually. By distributing instances of only offers matched to the defined interests of consumers, the vendor cost allocation tool can increase the likelihood that consumers only receive offers that they are interested in. The more targeted offers can help to lead to a higher redemption rate. The Activity Log Module 212 can record all activities and responses of consumers. For example, the Activity Log Module 212 can log the timestamps when the consumer logged on, when and how the interests of the consumer were updated, whether the consumer clicks on a presented offer instance, whether the consumer eventually makes a purchase, etc. These consumer activities can be used to analyze the matching performance and the purchase behaviors of the consumer, among other things. Preferably, the Activity Log Module 212 records all consumer activities and responses at the lowest level so that the records can support needs of potential future analysis. At Stage 850, a purchase transaction occurs. As illustrated in the description of Process 600 and Process 700, the purchase transaction can be conducted between the consumer and vendors and/or facilitated by the vendor cost allocation tool.

The vendor cost allocation tool can facilitate the purchase transaction that involves complicated, multi-component Offers. The vendor cost allocation tool can play an active role in facilitating the purchase transaction. In some situations, the vendor cost allocation tool can be instructed to carry out all steps for the purchase transition and then inform vendors to proceed to the fulfillment transaction. At Stage 860, a fulfillment transaction occurs. Similar to the purchase transaction, the fulfillment transaction can be conducted between the consumer and vendors and/or be facilitated by the vendor cost allocation tool. The vendor cost allocation tool can facilitate the fulfillment transaction by keeping all parties properly informed about the state of the fulfillment transaction. In more complicated Offers, the vendor cost allocation tool can play a more active role in facilitating the fulfillment transaction. As described earlier, the merchant performing the fulfillment transaction can be same as or different from the merchant fulfilling the purchase transaction. For example, if the consumer purchases a TV from a retail company A, a free DVD player can be provided as a fulfillment by the retail company A or by a manufacturing company B. At Stage 870, the transactions can be cleared and settled by the Clearing and Settlement Module 210. Payment and revenue sharing can be resolved among one or more of the consumer, vendors, the Community 120, and the vendor cost allocation tool. In case of multi-party offers, transaction among all parties can be settled at Stage 870. The vendor cost allocation tool can receive from vendors a commission fee for finding the consumer. The commission fee can be, for example, a fixed fee, a certain percentage of the purchase price, and/or in any form agreed upon between the vendor cost allocation tool and vendors.

Additional features that may be adapted for inclusion in systems and methods of the invention may be found discussed in U.S. Pat. No. 8,249,965 to Tumminaro; U.S. Pat. No. 8,239,275 to Lyren; U.S. Pat. No. 7,889,052 to Berardi; U.S. Pat. No. 7,866,548 to Reed; U.S. Pat. No. 6,575,361 to Graves; U.S. Pat. No. 5,155,342 to Urano; U.S. Pub. 2013/0018782 to Zhou; U.S. Pub. 2012/0078750 to Watkins; and U.S. Pub. 2009/0228372 to Jooste, the contents of each of which are incorporated by references for all purposes.

Systems and methods of the invention may generally be implemented through the use of one or more computer. A computer generally includes a processor operably coupled to a memory and configured to send or receive information via input-output device.

In certain embodiments, any of organizer device 105, participant device 141a, . . . ,141n, vendor device 115, or server computer 121 may be a notebook or desktop computer sold by Apple (Cupertino, Calif.) or a desktop, laptop, or similar PC-compatible computer such as a Dell Latitude E6520 PC laptop available from Dell Inc. (Round Rock, Tex.). Such a computer will typically include a suitable operating system such as, for example, Windows 7, Windows 8, Windows XP, all from Microsoft (Redmond, Wash.), OS X from Apple (Cupertino, Calif.), or Ubuntu Linux from Canonical Group Limited (London, UK). One of skill in the art will recognize that a processor may be provided by one or more processors including, for example, one or more of a single core or multi-core processor (e.g., AMD Phenom II X2, Intel Core Duo, AMD Phenom II X4, Intel Core i5, Intel Core i& Extreme Edition 980X, or Intel Xeon E7-2820).

In some embodiments, any of organizer device 105, participant device 141a, . . . ,141n, vendor device 115, or server computer 121 may be a tablet or smart-phone form factor device such as an iPhone or Samsung Galaxy S2 and processor 281 can be provided by, for example, an ARM-based system-on-a-chip (SoC) processor such as the 1.2 GHz dual-core Exynos SoC processor from Samsung Electronics, (Samsung Town, Seoul, South Korea). One of skill in the art will recognize that a processor may be provided by, for example, an ARM-based system-on-a-chip (SoC) processor such as the 1.2 GHz dual-core Exynos SoC processor from Samsung Electronics, (Samsung Town, Seoul, South Korea).

In some embodiments, server computer 121 can be a dedicated server computer such as, for example, a Hitachi Compute Blade 500 computer device sold by Hitachi Data Systems (Santa Clara, Calif.). Processor 129 can be, for example, a E5-2600 processor sold under the trademark Xeon by Intel Corporation (Santa Clara, Calif.).

Input-output devices generally includes one or a combination of monitor, keyboard, mouse, data jack (e.g., Ethernet port, modem jack, HDMI port, mini-HDMI port, USB port), Wi-Fi card, network card (“NIC”), modem, touchscreen (e.g., CRT, LCD, LED, AMOLED, Super AMOLED), pointing device, trackpad, microphone, speaker, light (e.g., LED), or light/image projection device.

A memory generally refers to one or more storage devices for storing data or carrying information, e.g., semiconductor, magnetic, magneto-optical disks, or optical disks. Information carriers for a memory suitable for embodying computer program instructions and data include any suitable form of memory that is tangible, non-transitory, non-volatile, or a combination thereof. In certain embodiments, a device of the invention includes a tangible, non-transitory computer readable medium for memory. Exemplary devices for use as memory include semiconductor memory devices, (e.g., EPROM, EEPROM, solid state drive (SSD), and flash memory devices e.g., SD, micro SD, SDXC, SDIO, SDHC cards); magnetic disks, (e.g., internal hard disks or removable disks); magneto-optical disks; and optical disks (e.g., CD and DVD disks). The processor and the memory can be supplemented by, or incorporated in, special purpose logic circuitry.

As used herein, the word “or” means “and or or”, sometimes seen or referred to as “and/or”, unless indicated otherwise.

### INCORPORATION BY REFERENCE

References and citations to other documents, such as patents, patent applications, patent publications, journals, books, papers, web contents, have been made throughout this disclosure. All such documents are hereby incorporated herein by reference in their entirety for all purposes.

### Equivalents

Various modifications of the invention and many further embodiments thereof, in addition to those shown and described herein, will become apparent to those skilled in the art from the full contents of this document, including references to the scientific and patent literature cited herein. The subject matter herein contains important information, exemplification and guidance that can be adapted to the practice of this invention in its various embodiments and equivalents thereof.

What is claimed is:

1. A method for coordinating participation in an event, the method comprising:
receiving information about an event and storing the information in a tangible, non-transitory memory in a computer system;
sharing the information with a participant;
receiving, in the computer system, an acceptance from the participant;
initiating, by the processor, payment of a total cost of the event; and
charging an event leader and the participant an allocated cost.

2. The method of claim 1, further comprising sending an event invitation to the participant.

3. The method of claim 1, further comprising obtaining a total cost of the event and information about allocation of the cost.

4. The method of claim 1, wherein the allocated cost charged to the event leader is less than the total cost.

5. The method of claim 1, further comprising receiving acceptances by a plurality of participants.

6. The method of claim 1, wherein the event is one selected from the list of a concert; a road trip; a hotel stay; a restaurant dinner; a movie; a shopping trip; and an amusement park visit.

7. A method of organizing an event, the method comprising:
broadcasting, through the operation of a processor, information about an event;
receiving a commitment to pay from participants; and
initiating, by means of the processor, charging credit cards of the participants.

8. The method of claim 7, wherein each no participant is charged a total cost of the event.

9. The method of claim 7, further comprising receiving credit card information from a participant prior to receiving a commitment to pay from a participant.

10. The method of claim 7, wherein a participant's commitment to pay is included in a communication indicating an intent to participate in the event.

11. The method of claim 7, wherein the broadcasting is initiated by one of the participants.

12. The method of claim 11, wherein the broadcasting is initiated after the event is underway.

13. The method of claim 11, wherein the broadcasting is initiated through the use of a portable electronic device after a bill is received.

14. A method for planning an event, the method including using a computer comprising a memory coupled to processer to perform the following steps:
sending an invitation regarding an event;
initiating payment of a total cost of the event; and
paying an amount less than a total cost of the event.

15. A method of planning an event, the method comprising, by means of a computer:
broadcasting an invitation;
receiving from a participant a commitment to pay a share of a total cost; and
initiating a full payment to a vendor while paying less than the total cost, wherein the full payment includes the share contributed by the participant.

16. A system for coordinating participation in an event, the system comprising:
a computer device comprising a tangible, non-transitory memory coupled to a processor and configured to:
send, at the initiative of a leader person, an invitation to one or more participants;
receive, a communication from at least one participant indicating an intention to participate in an event and a commitment to pay; and
initiate payment for a cost of the event, wherein payment comprises a contribution from each of the one or more participants and the leader of an amount less than the cost of the event.

17. The system of claim 16, wherein receiving the communication causes a digital record to be made including a date, a time, and a list of participants in the event, and further wherein the digital record is made available to the participants.

18. The system of claim 16, wherein the invitation is sent through the use of a mobile app.

19. The system of claim 16, wherein the invitation is sent through the use of computer program functionality accessed via a web site.

20. The system of claim 19, wherein the web site is a social networking web site.

21. The system of claim 16, wherein the invitation is sent and the communication is received prior to the event.

22. The system of claim 21, wherein payment is initiated prior to the event.

23. The system of claim 16, wherein the invitation is sent, the communication is received, and the payment is initiated during the event.

24. The system of claim 16, wherein the initiation of payment comprises causing payment to happen predominantly outside of the system.

26. A computer system for coordinating events comprising:
a server computer comprising a processor coupled to a tangible, non-transitory memory and configured to:
relay a communication from a leader person to a participant person, the communication including information about an event;
receive from a participant a digital signal indicating a willingness to pay to participate in the event;
initiate payment for a full cost of the event; and
initiate charging a partial cost of the event to the leader person and a allocated partial cost of the event to the participant person.

27. The computer system of claim 26, further configured to:
receive sign-up information from a participant person, the sign-up information including payment information.

28. The computer system of claim 27, wherein the communication is relayed to the participant person only if the sign-up information has been received.

29. The system of claim 27, wherein the payment information is one selected from the list consisting of: credit card number; bank account number; pre-payment deposit; online payment service agreement; a contractual agreement; authorization to issue a check; debit card number;
payment card number; and gift card data.

30. A method for making a purchase, the method comprising:
receiving information about a purchase and storing the information in a tangible, non-transitory memory in a computer system;
sharing the information with a participant;
receiving, in the computer system, an acceptance from the participant;
initiating, by the processor, payment of a total cost of the purchase; and
charging an event leader and the participant an allocated cost.

31. The method of claim 30, wherein the event leader uses the processor for the initiating of the total cost and subsequently presents a request for payment of the allocated cost to the participant.

32. The method of claim 31, wherein the event leader uses the computer system to present a second request for payment to a second participant.

33. The method of claim 30, wherein the event leader uses the computer system to establish specified minimums and maximum participant levels and cost amounts to determine a range of financial obligations.

34. The method of claim 30, wherein the event leader pays no more than the allocated cost and the allocated cost is less than the total cost.

35. The method of claim 30, wherein payment is initiated after collecting the allocated cost from the participant.
